(19) United States
(12) Patent Application Publication
(10) Pub. No.: US 2023/0365099 A1
(43) Pub. Date: Nov. 16, 2023

(54) DRIVE SPRING FOR A BELT RETRACTOR, AND BELT RETRACTOR

(71) Applicants: ZF AUTOMOTIVE GERMANY GMBH, Alfdorf (DE); ZF AUTOMOTIVE SYSTEMS POLAND SP .Z.O.O., Czestochowa (PL)

(72) Inventors: Friedrich LITTAU, Rienharz (DE); Jan JURA, Czestochowa (PL); Dennis ZOLNAI, Schwäbisch Gmünd (DE)

(21) Appl. No.: 18/027,938

(22) PCT Filed: Sep. 16, 2021
(86) PCT No.: PCT/EP2021/075412

§ 371 Date: Mar. 23, 2023

(30) Foreign Application Priority Data
Sep. 24, 2020 (DE) 10 2020 124 878.4

(51) Int. Cl. B60R 22/44

(52) U.S. Cl. CPC B60R 22/44; B60R 2022/4406

(57) ABSTRACT

The invention describes a mainspring (10) for a belt retractor (24). Furthermore, a belt retractor (24) for a seat belt device of a vehicle is provided which comprises a belt reel (26) which is supported rotatably about a central axis (26a) in a belt retractor housing (28), and a mainspring (10) for rotationally restoring the belt reel (26). Accordingly, the mainspring (10) includes plural windings (30) extending in a substantially helically nested manner in its state mounted in the belt retractor (24). The mainspring (10) is disposed substantially concentrically to the central axis (26a).

### TECHNICAL FIELD

The invention relates to a mainspring for a belt retractor comprising a strip-shaped spring body extending substantially S-shaped in a relaxed state. Accordingly, each of a first end of the spring body and a second end of the spring body has a helically wound portion of the spring body. In addition, the second end is opposed to the first end. Also, a winding direction at the second end is opposed to a winding direction at the first end.

### BACKGROUND

Further, the invention relates to a belt retractor for a seat belt device of a vehicle, comprising a belt reel supported rotatably about a central axis in a belt retractor housing, and a mainspring for rotationally resetting the belt reel to an idle position. The mainspring includes, in its state mounted in the belt retractor, plural windings which extend in a substantially helically nested manner. An inner end of the mainspring is connected to the belt reel and an outer end of the mainspring that is opposed to the first end is connected to the belt retractor housing.

Mainsprings of this type and belt retractors of this type are known from prior art. On the one hand, they serve to retain a webbing in its wound-up idle state biased within the belt retractor. On the other hand, they serve to introduce a restoring moment to the belt reel so that webbing can be transferred, starting from an unwound state, into its idle state again. In so doing, an S-shaped extension of the spring body also includes a mirror-inverted S-shaped extension, as a matter of course.

Since mainsprings and belt retractors are usually employed in cars, they are subjected to intense cost pressure. At the same time, utmost requirements are made to the reliability and the service life of the mainsprings and the belt retractors.

Against this background, it is the object of the invention to further improve mainsprings of the above-mentioned type and belt retractors of the above-mentioned type. Accordingly, specifically mainsprings and belt retractors are to be created which can be manufactured easily and inexpensively and simultaneously are reliable and long-lasting in operation.

### SUMMARY

The object is achieved by a mainspring of the above-mentioned type in which a run of the reciprocal of the radius of curvature of the spring body has an inflection point over the length of the spring body. In technical terms, the reciprocal of the radius of curvature frequently is also simply referred to as curvature. The inflection point is to be understood in the mathematical sense. This means that in a diagram in which the reciprocal of the radius of curvature is applied over the length of the spring body in the inflection point the sign of the second derivative of the radius of curvature changes in the inflection point over the length. The graph representing the radius of curvature thus changes in the inflection point either from convex to concave, or vice versa. The afore-mentioned characteristics show in the relaxed state of the spring which simultaneously is a state in which the spring is not mounted in a belt retractor. Accordingly, those mainsprings, when used in a belt retractor, cause comparatively low friction, as the portions of those mainsprings are not or at least only slightly adjacent to each other. At the same time, those mainsprings help provide a restoring moment that has a comparatively small hysteresis vis-à-vis known mainsprings. As a result, mainsprings according to the invention are specifically long-lasting and specifically reliable during operation. Further, mainsprings according to the invention may be designed to be weaker and/or shorter than state-of-the-art mainsprings, while their function remains the same. This results in a reduced associated manufacturing expenditure. In other words, the mainsprings can be manufactured easily and inexpensively.

Preferably, at both ends of the spring body at least one winding of the helically wound portion extends, vis-à-vis its neighboring windings, radially relative to an associated winding axis in a contactless manner. Specifically, at both ends of the spring body all windings extend, vis-à-vis their respective neighboring windings, radially relative to an associated winding axis in a contactless manner. This, too, contributes to the fact that the portions of the mainspring, when used in a belt retractor, get only minimally or not at all in friction contact. Also, this configuration causes a comparatively small hysteresis in providing the restoring moment.

In addition, the object is achieved by a belt retractor of the above-mentioned type in which the mainspring is disposed substantially concentrically to the central axis. Due to the fact that the mainspring is used to reset the belt reel to its idle position, it can alternatively be referred to as return spring. A concentric arrangement has to be understood in a broad sense in this context. Specifically, the deviations from a strict concentricity resulting from the helical shape are negligible. Connections of the mainspring, too, which are provided for connecting the same to the belt reel or the belt retractor usually do not extend perfectly concentrically. The concentric arrangement, thus, is globally applicable to the mainspring but not to each detail thereof. In such belt retractor, the restoring moment acting on the belt reel has only a small hysteresis. This means that, when unwinding webbing from the belt reel, substantially the same restoring moment run must be overcome which, when unwound webbing is released, acts on the latter and returns it to the wound state. This is due to the fact that the individual windings of the mainspring do not at all or only slightly contact each other. As a result, during operation of the belt retractor, there is only little friction between neighboring portions of the mainspring. Moreover, due to this effect, a spring force provided by the mainspring is converted specifically efficiently to a restoring moment acting on the belt reel and, resp., to a restoring force acting on webbing connected to the belt reel. In contrast to prior art, the belt retractor therefore can be equipped with a smaller and thus lighter mainspring, while maintaining the same effect. This results in reduced expenditure for manufacturing the belt retractor. At the same time, the belt retractor can be built to be smaller and lighter. Furthermore, the absence of the afore-described friction effect brings about high reliability and long service life of the belt retractor.

According to one embodiment, at least one of the windings extends in a contactless manner in the radial direction vis-à-vis its neighboring windings. Specifically, all windings extend in a contactless manner in the radial direction vis-à-vis their respective neighboring windings. Contactless means in this context that the windings are not in contact with each other in the radial direction. The radial direction relates to a winding axis which, in the present case, coincides with the central axis of the belt reel. From this configuration, too, compared to known belt retractors an at least strongly reduced, if not completely eliminated friction between individual windings of the mainspring is resulting. The already mentioned effects of a simple and inexpensive manufacture as well as a long service life and a high reliability of the belt retractor are resulting to a particular extent.

The mainspring can be arranged concentrically to the central axis both in an idle position of the belt reel which corresponds to a retracted position of a webbing adapted to be coupled to the belt reel, and in an operating position which corresponds to a fully or partly extended position of the webbing adapted to be coupled to the belt reel. Alternatively, or additionally, at least one of the windings extends in a contactless manner in the radial direction both in the idle position and in the operating position. In other words, the concentric arrangement and/or the radial contactless state remain independent of a rotary position of the belt reel and, thus, independent of a position of the webbing adapted to be coupled to the belt reel throughout all situations occurring during operation of the belt retractor. Therefrom the already described effects and advantages are resulting.

Of preference, the mainspring applies a biasing moment to the belt reel in the idle position. In this way, in the idle position the belt reel and a webbing possibly connected to the belt reel are maintained in a defined rotational position. Preferably, the biasing moment is generated by the belt reel being rotated in its idle position about 5 to 15, preferably about 8 to 12, revolutions against the force of the mainspring. This results in the belt retractor being reliable and long-lasting during operation.

Also, the mainspring can apply a restoring moment acting in the direction of the idle position to the belt reel in the operating position. The restoring moment serves to return the belt reel and a webbing possibly coupled to the belt reel, starting from an operating position in which the webbing is at least partially wound off the belt reel, to the idle position again. To this end, the webbing only has to be released. This, too, serves for a reliable and long-lasting function of the belt retractor.

Advantageously, a torque characteristic of the mainspring runs degressively in response to revolutions of the belt reel which are associated with an operating range. In a diagram in which a torque acting upon the belt reel, specifically a restoring moment, is applied via those revolutions of the belt reel which the latter carries out during operation, the graph representing the torque thus behaves degressively. This means that the increase in the restoring moment resulting from each additional revolution of the belt reel decreases with an increasing number of revolutions. For a user of the belt retractor this results in a convenient behavior of the belt retractor perceived as comfortable. Known belt retractors in this context frequently have a linear torque characteristic so that a webbing coupled to the belt reel is frequently perceived as stiff, when significant parts thereof have already been wound off the belt reel.

The belt retractor may be equipped with a mainspring according to the invention. Thus, the effects and advantages of high reliability and long service life already explained as regards the mainspring, while the manufacturing expenditure is low, are also resulting for the belt retractor.

### BRIEF DESCRIPTION OF THE DRAWINGS

In the following, the invention shall be illustrated by means of an embodiment which is shown in the attached drawings, and wherein:

FIG. 1 shows a mainspring according to the invention in a relaxed state not installed in a belt retractor,

FIG. 2 shows a detail II of the mainspring of FIG. 1,

FIG. 3 shows a shape of a radius of curvature (continuous line) and of a reciprocal of the radius of curvature (broken line) over a length of the mainspring according to the invention of FIGS. 1 and 2,

FIG. 4 shows a shape of a diameter of the mainspring according to the invention over its length during a first manufacturing step (continuous line) and a course of a diameter of the mainspring according to the invention over its length during a second manufacturing step (broken line),

FIG. 5 shows a shape of a radius of curvature of the mainspring according to the invention over its length when the first manufacturing step is completed and before the second manufacturing step is started,

FIG. 6 shows a belt retractor according to the invention in a lateral view, with a cover being removed so that a mainspring installed in the belt retractor is visible, and

FIG. 7 shows a shape of a torque acting on a belt reel of the belt retractor of FIG. 6 as a function of a rotational position of the belt reel.

### DESCRIPTION

FIG. 1 shows a mainspring 10 according to the invention in a relaxed state in which it is not installed in a belt retractor.

The mainspring 10 comprises a strip-shaped spring body 12 which, in the shown perspective, extends substantially in the form of a mirror-inverted S and, hence, is S-shaped.

A first end 14 of the spring body 12 is provided to be secured to a belt reel.

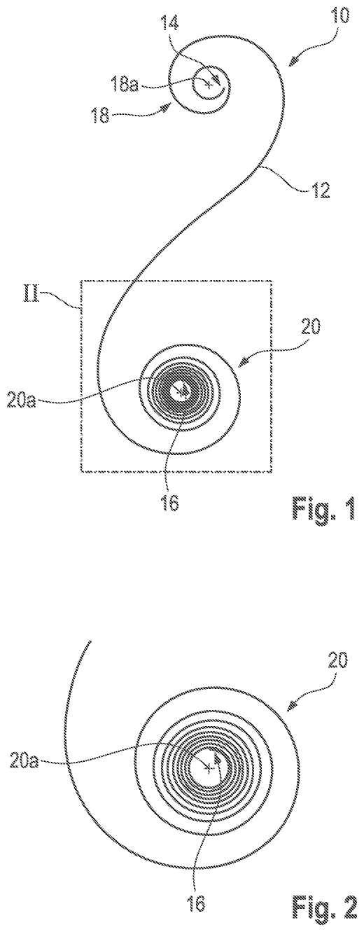

A second end 16 (see also FIG. 2) is provided to be secured to a belt retractor housing.

Accordingly, the first end 14 includes a portion 18 that is wound helically with respect to a first winding axis 18a. All windings of said portion 18 extend in a radially contactless manner relative to their respective neighboring windings, the winding axis 18a serving as a reference geometry for the radial contactless extension.

The second end 16 has a portion 20 that is wound helically with respect to a second winding axis 20a. All windings of the portion 20, too, extend in a radially contactless manner relative to their respective neighboring windings with respect to the winding axis 20a.

The winding directions of the portions 18 and 20 are oppositely oriented.

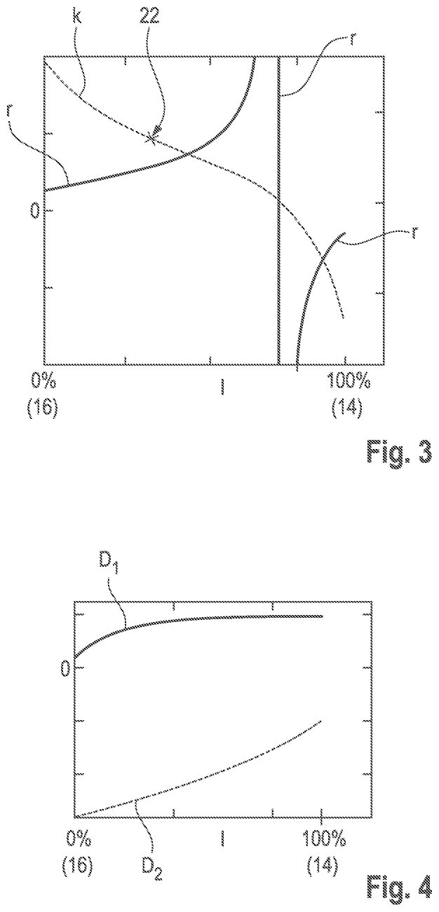

The exact shape of the radius of curvature r of the spring body 12 over its length l is shown by a continuous line in FIG. 3. The length l of the spring body 12 is applied in percentages. The indicated length of 0% corresponds to the second end 16 and the indicated length of 100% corresponds to the first end 14.

The opposite winding directions of the portions 18 and 20 manifest in the diagram of FIG. 3 in that the radii r are provided with different signs at the ends 14, 16.

At the position where the length l is about 70%, the radius r is infinite. This corresponds to the substantially straightly extending portion in the center of the S-shaped spring body 12.

Moreover, in the diagram of FIG. 3, a shape of the reciprocal k of the radius of curvature r over the length l of the spring body 12 is applied by a broken line. Said reciprocal k will be referred to as curvature in the following.

The graph representing the curvature has an inflection point 22 at a length l of about 30%. Based on a length of 0%, in the inflection point 22 the graph representing the curvature thus changes from concave to convex.

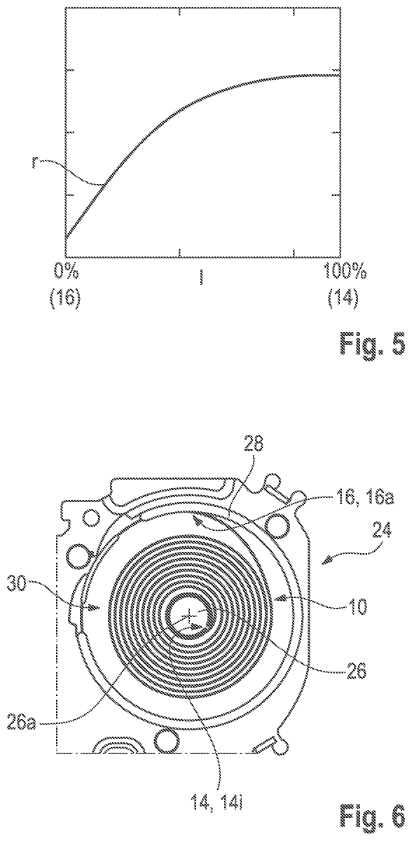

In the following, the manufacture of such mainspring 10 shall be illustrated by means of FIGS. 4 and 5.

In this context, a strip-shaped starting material of the spring body 12 is initially wound around a first mandrel so that the diameter shape D1 over the length l of the spring body 12 applied in FIG. 4 by a continuous line is resulting.

Accordingly, again a length l of 0% corresponds to the second end 16 and a length l of 100% corresponds to the first end 14.

The spring body 12 can be wound onto the first mandrel so that neighboring windings are at least partially overlapping.

As a result of said first manufacturing step, the spring body 12 in an intermediate state has a radius of curvature r of continuous shape, which is shown in FIG. 5. Due to the continuously increasing radius of curvature r, the spring body 12 in this intermediate state can also be referred to as conical.

In a second manufacturing step, the spring body 12 having the radius of curvature r according to FIG. 5 is wound onto a second mandrel in the opposite direction (negative diameter values) so that the diameter shape D2 shown by a broken line in FIG. 4 is resulting.

The result of the second manufacturing step is the mainspring 10 according to FIGS. 1 and 2.

FIG. 6 illustrates a belt retractor 24 for a seat belt device of a vehicle. It is equipped with a mainspring 10 according to FIGS. 1 and 2 in the shown embodiment.

Accordingly, the first end 14 is connected to a belt reel 26 which is rotatably supported about a central axis 26a in a belt retractor housing 28.

The first end 14 thus constitutes, in the mounted state, an inner end 14i of the mainspring 10.

The second end 16 is connected to the belt retractor housing 28. The second end 16 thus constitutes an outer end 16a of the mainspring 10 in the mounted state.

Between the two ends 14i, 16a, the mainspring 10 includes plural windings 30 which extend in a substantially helically nested manner.

In order to achieve this, starting from its relaxed state shown in FIG. 1, the mainspring 10 is wound helically oppositely its radius of curvature.

Accordingly, all windings 30 extend relative to their respective neighboring windings in a contactless manner in the radial direction, i.e., radially with respect to the central axis 26a.

For reasons of clarity, in FIG. 6 the windings are provided only as a whole with the reference numeral 30.

The mainspring 10 is disposed substantially concentrically to the central axis 26a. This applies also to the spring body 12 which, as seen globally, is equally disposed substantially concentrically to the central axis 26a.

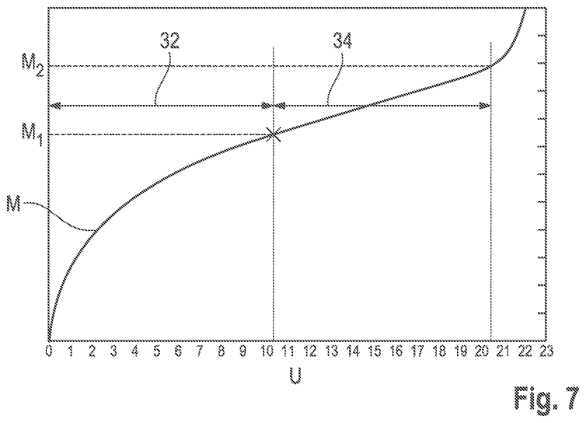

The mainspring 10 serves for rotationally restoring the belt reel 26 to an idle position, as shall be illustrated hereinafter with the aid of the diagram of FIG. 7, in which a shape of a torque M acting on the belt reel 26 is applied as a function of a rotational position, i.e., as a function of a number of revolutions U, of the belt reel.

FIG. 6 shows the belt retractor 24 in an idle position of the belt reel 26 which corresponds to a retracted position of webbing adapted to be coupled to the belt reel 26, which is not shown in detail.

In this position, the mainspring 10 applies a biasing moment M1 to the belt reel 26 (see FIG. 7).

This results from the belt reel 26 being rotated against a spring force resulting from the mainspring 10 by approx. 10.5 revolutions relative to the belt retractor housing 28.

The range of the shape of the torque M between 0 and 10.5 revolutions thus can be referred to as biasing range 32.

When, based on this fact, the belt reel 26 is rotated further, i.e., by more than 10.5 revolutions, relative to the belt retractor housing 28, the torque M acting on the belt reel 26 will continue to increase.

Accordingly, the torque M acts as a restoring moment acting in the direction of the idle position and being exerted on the belt reel 26 by the mainspring 10.

The restoring moment increases in a degressive manner up to an associated maximum value M2.

The maximum restoring moment M2 is reached at 20.5 revolutions of the belt reel 26 relative to the belt retractor housing 28. This corresponds to a state in which the webbing not shown in detail is maximally wound off.

The shape of the torque M in the range between 10.5 and 20.5 revolutions therefore occurs in connection with winding and unwinding operations of the webbing. Therefore, this section of the shape of the torque M is also referred to as operating range 34.

The mainspring 10 is designed so that it is disposed concentrically to the central axis 26a both in the idle position and throughout the entire operating range 34.

Moreover, the windings 30 remain radially contactless both in the idle position and in any position within the operating range 34.

1-9. (canceled)

10. A mainspring (10) for a belt retractor (24) comprising a strip-shaped spring body (12) extending substantially in S-shape in the relaxed state,
wherein each of a first end (14) of the spring body (12) and a second end (16) of the spring body (12) has a helically wound portion (18, 20) of the spring body (12) and the second end (16) is opposed to the first end (14), and
wherein a winding direction at the second end (16) is opposed to a winding direction at the first end (14),
wherein
a shape of the reciprocal (k) of the radius of curvature (r) of the spring body (12) has an inflection point (22) over a length (l) of the spring body (12).

11. The mainspring (10) according to claim 10, wherein at each of the two ends (14, 16) of the spring body (12) at least one winding of the helically wound portion (18, 20) extends, vis-à-vis its neighboring windings, radially relative to an associated winding axis (18a, 20a) in a contactless manner, specifically wherein at both ends (14, 16) of the spring body (12) all windings extend, vis-à-vis their respective neighboring windings, radially relative to an associated winding axis (18a, 20a) in a contactless manner.

12. A belt retractor (24) for a seat belt device of a vehicle, comprising
a belt reel (26) rotatably supported about a central axis (26a) in a belt retractor housing (28), and
a mainspring (10) for rotationally restoring the belt reel (26) to an idle position,
wherein the mainspring (10) in its state mounted in the belt retractor (24) includes plural windings (30) which extend in a substantially helically nested manner, wherein an inner end (14i) of the mainspring (10) is connected to the belt reel (26) and an outer end (16a) of the mainspring (10) being opposed to the inner end (14i) is connected to the belt retractor housing (28),
wherein
the mainspring (10) is disposed substantially concentrically to the central axis (26a).

13. The belt retractor (24) according to claim 12, wherein at least one of the windings (30) extends, vis-à-vis its neighboring windings (30), in the radial direction in a contactless manner, specifically wherein all windings (30) extend, vis-à-vis their respective neighboring windings (30), in the radial direction in a contactless manner.

14. The belt retractor (24) according to claim 12, wherein the mainspring (10) is arranged concentrically to the central axis (26a) both in an idle position of the belt reel (26) which corresponds to a retracted position of webbing adapted to be coupled to the belt reel (26) and in an operating position which corresponds to a fully or partly extended position of the webbing adapted to be coupled to the belt reel (26), and/or
at least one of the windings (30) extends in the radial direction in a contactless manner both in the idle position and in the operating position.

15. The belt retractor (24) according to claim 14, wherein the mainspring (10) applies a biasing moment (M₁) to the belt reel (26) in the idle position.

16. The belt retractor (24) according to claim 14, wherein the mainspring (10) applies a restoring moment acting in the direction of the idle position to the belt reel (26) in the operating position.

17. The belt retractor (24) according to claim 12, wherein a torque characteristic (M) of the mainspring (10) runs degressively as a function of revolutions (U) of the belt reel (26) which are associated with an operating range (34).

18. The belt retractor (24) according to claim 12, wherein the mainspring (10) is a strip-shaped spring body (12) extending substantially in S-shape in the relaxed state,
wherein each of a first end (14) of the spring body (12) and a second end (16) of the spring body (12) has a helically wound portion (18, 20) of the spring body (12) and the second end (16) is opposed to the first end (14), and
wherein a winding direction at the second end (16) is opposed to a winding direction at the first end (14),
wherein a shape of the reciprocal (k) of the radius of curvature (r) of the spring body (12) has an inflection point (22) over a length (l) of the spring body (12).
